(19) United States
(12) Patent Application Publication
(10) Pub. No.: US 2010/0318427 A1
(43) Pub. Date: Dec. 16, 2010

(54) ENHANCING DATABASE MANAGEMENT BY SEARCH, PERSONAL SEARCH, ADVERTISING, AND DATABASES ANALYSIS EFFICIENTLY USING CORE-SET IMPLEMENTATIONS

(75) Inventor: Ofer Miranda, Tel-Aviv (IL)

Correspondence Address: The Law Office of Michael E. Kondoudis, 888 16th Street, N.W., Suite 800, Washington, DC, 20006, US

(73) Assignee: MYOGGER LTD, Tel-Aviv (IL)

(21) Appl. No.: 12/814,461

(22) Filed: Jun. 13, 2010

Related U.S. Application Data
(60) Provisional application No. 61/186,859, filed on Jun. 14, 2009.

(51) Int. Cl. G06Q 30/00; G06F 17/30

(52) U.S. Cl. 705/14.66; 705/14.49; 707/748; 707/E17.044; 707/769

(57) ABSTRACT

A computerized method of reducing complexity of data analysis including an inverse search process over a plurality of multimedia content elements mapped to points in a d-dimensional space, and by that improves search, advertising and database analysis efficiency. The computerized method comprises the stages: (i) mapping the points to core-set points, comprising a weighted set of points that represents the points according to predefined geometrical relationships, such that the number of the core-set points is substantially smaller than the number of the points; (ii) inversely projecting the core-set points to receive weighted multimedia content elements, such that weighting is carried out in relation to the geometrical relationships among the core-set points; and (iii) applying at least one inverse search algorithm to the weighted multimedia content elements.

### CROSS-REFERENCE TO RELATED APPLICATIONS

This application claims the benefit under 35 U.S.C. §119(e) of U.S. Provisional Patent Application No. 61/186,859 filed Jun. 14 2010, the content of which is incorporated by reference herein.

### BACKGROUND

1. Technical Field

The present invention relates to the field of managing including searching content databases, as an example improving search, advertising and database analysis efficiency.

2. Discussion of Related Art

What's on a user's mind? Although data and internet consumers can navigate to any local and public site on the network, and type any query that comes to mind, the main problem of any search is that our mind is not made out of text queries and URLs. All the purposes, desires and expectations of the user during the inquire or surf session need to be converted into very few terms of a text query. If the chosen terms are poorly chosen, the user extract or surfs to non-relevant sites, regardless of the quality of the search engine that runs the query.

But even if the user succeeds in choosing terms that reflect his/her state of mind, it is not clear that these terms are the most suitable ones for the query: The sites that contain the desired content might use different terms and associations. Inevitably, users are not familiar with all the content on the internet as well as on the data werehouse, and might choose terms that reflect their thoughts, but are too specific or too general for getting good results from the search engine. For example, if a user wants information on Macintosh computer through the net, it is not clear which terms should be used in the search query: “buy computer”, “apple, but not the fruit”, “small and cheap”, “computer stores”, etc. Since a search engine is not “aware” of the user's mind, and the user's mind is not aware to most of the internet content and not aware of all the stored raw content in the data warehouse, the results of typing queries in a search engine are usually less efficient than they could be.

Searching for information, links and accusations in data warehouse and the internet is frequently a frustrating process, commonly involving changing and refining the search queries. Due to the huge number of information, documents, webpage, algorithms for optimizing and fitting search queries to user are inefficient. This is also relevant for users who do not search by queries or using search engines, but instead prefer to browse and search for relevant content by direct navigation (i.e. by clicking on links, ads., multimedia content elements etc.). Understanding the users intent, and finding the optimal query based on the user browsing behavior is very important, in order to deliver the user a personalized and relevant content as well as targeted advertisements. However, as mentioned above, due to the huge number of information, content and webpages it is very difficult to understand the user's intent and his specific search goal. Current systems and methods are not enough efficient for this purpose especially because of the need to analyze a large amount of date in a very short time.

A well known mathematical model for web-pages is called “Latent Semantic Analysis” where each web-page is mapped to a point in a high dimensional space. A query that contains a single term is mapped to a line, a query that contains two terms is mapped to a plane, etc. In a regular search, the input is a plane which corresponds to the query. The output is a set of points that are near the plane, which corresponds to documents that are related to this query.

The 2006 paper “Coresets for Weighted Facilities and Their Applications” by Feldman, D., Fiat, A. and Sharir, M. in the Proceedings of the 47th Annual IEEE Symposium on Foundations of Computer Science, pages: 315-324, which is incorporated herein by reference in its entirety, discloses efficient (1+ε-approximation algorithms for generalized facility location problems.

The following papers are incorporated herein by reference in their entirety: “Constant-factor approximation algorithm for the k-median problem” by Charikar, M., Guha, S., Tardos, E. and Shmoys, D. B.; the 2006 paper “Matrix Approximation and Projective Clustering via Volume Sampling” by Deshpande, A., Rademacher, L., Vempala, S. and Wang, G. in the Theory of Computing, 2, 225-247; “A Data Miner Analyzing the Navigational Behaviour of Web Users” by Spiliopoulou, M., Faulstich, L. C., Winkler, K.; and “Feedback-Directed Query Optimization” by Hazelwood, K., Harvard University. Specifically, the last two examples demonstrate prior art changing of mapping according to user queries.

### BRIEF SUMMARY

Embodiments of the present invention provide computerized methods of reducing complexity of an inverse search process over a plurality of multimedia content elements mapped to a plurality of points in a d-dimensional space. One computerized method comprises: mapping the plurality of points to a plurality of core-set points, comprising a weighted set of points that represents the plurality of points according to predefined geometrical relationships, such that the number of the core-set points is substantially smaller than the number of the points; inversely projecting the plurality of core-set points to receive a plurality of weighted multimedia content elements, such that weighting is carried out in relation to the geometrical relationships among the plurality of core-set points; and applying at least one inverse search algorithm to the plurality of weighted multimedia content elements and/or generating at least one targeted advertisement based on it.

Another computerized method comprises: generating a knowledge map with initial weighting; receiving a user search session comprising at least one search query; calculating a user web map with weights relating to the user session; applying at least one core-set algorithm to represent the points in the user web map by a weighted set of points according to predefined geometrical relationships, such that the number points in the weighted set is substantially smaller than the number of the points in the user web map, and such that weighting is carried out in relation to the predefined geometrical relationships; inversely projecting the weighted set of points to receive a reduced core-sets user web map; applying at least one inverse search algorithm to the reduced core-sets user web map; generating at least one enhanced query and/or targeted advertisement based on it; and reiterating the method interactively with the user.

Embodiments of the present invention further provide data processing systems for enhancing a search session applicable to a search engine. One data processing system comprises a mediator server. The mediator server is connected via a communication link to the search engine and arranged to receive user session from the search engine. The mediator server comprising: a database and an application. The database is arranged to comprise at least one weighed representation of the web comprising a plurality of points, wherein the weights relate to the user session; and at least one core-set representation of the weighed representation of the web, the at least one core-set representation comprising a weighted set of points that represents the plurality of points according to predefined geometrical relationships, such that the number of the points in the weighted set is substantially smaller than the number of the points in the weighed representation of the web. The application is arranged to calculate the at least one core-set representation from the weighed representation of the web; further arranged to inversely project the at least one core-set representation to receive a plurality of weighted multimedia content elements, such that weighting is carried out in relation to the geometrical relationships among the points in the weighted set; and further arranged to carry out at least one inverse search algorithm. The mediator server is arranged to engage in a session with a user via the search engine, during the session the mediator server may generate enhanced search queries and/or targeted advertisements relating to the user session.

Another computerized method comprises: generating a knowledge map with initial weighting; receiving users network sessions comprising at least one activity (for example in Telecommunication network—phone calls activity, send/receive SMS, databases—correlations and relations between documents and other content materials. etc. in the Web—browsing behavior—click on links etc.); calculating a user network map with weights relating to the user session; applying at least one core-set algorithm to represent the points in the user network map by a weighted set of points according to predefined geometrical relationships, such that the number points in the weighted set is substantially smaller than the number of the points in the user network map, and such that weighting is carried out in relation to the predefined geometrical relationships; inversely projecting the weighted set of points to receive a reduced core-sets user network map; In web network may also applying at least one inverse search algorithm to the reduced core-sets user web map; generating at least one enhanced query and/or targeted advertisement based on it; and reiterating the method interactively with the user. In telecommunication or other social network applying it for identifying influential persons and users intents according to their activities that may be monitored and analyzed by the systems and methods;

### BRIEF DESCRIPTION OF THE DRAWINGS

The present invention will be more readily understood from the detailed description of embodiments thereof made in conjunction with the accompanying drawings of which:

FIG. 1 is a flowchart illustrating a computer implemented method of enhancing a search session applicable to a search engine, according to some embodiments of the invention;

FIG. 2 is a flowchart illustrating a computerized method of reducing complexity of an inverse search process over a plurality of multimedia content elements mapped to a plurality of points in a d-dimensional space, according to some embodiments of the invention;

FIG. 3 is a flowchart illustrating a computerized method of reducing complexity of an inverse search process over a plurality of multimedia content, according to some embodiments of the invention;

FIG. 4 is a block diagram illustrating a data processing system for enhancing a search session applicable to a search engine, according to some embodiments of the invention;

FIG. 5 is an illustration of web representations with inputs and outputs, according to some embodiments of the invention;

FIG. 6 is a block diagram illustrating the information flow in a data processing system for enhancing user search sessions applicable to a search engine in a search engine farm, according to some embodiments of the invention;

FIG. 7 is an illustration of the dynamic focus of the system and method on user's intentions in the search, according to some embodiments of the invention;

FIG. 8 is a high level schematic block diagram of personalized and targeted advertising system utilizing methods described in some embodiments of the invention;

FIG. 9 is a high level schematic flowchart illustrating a method of generating personalized advertising relating to behavioral characteristics of content browsing of the user, according to some embodiments of the invention; and

FIG. 10 is a high level schematic flowchart illustrating a method of identifying influential persons and users intention and characteristics by the analyzing the characteristics of the network behavior of users in relation to their activities, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention discloses computer implemented methods and systems enhancing search efficiency by effectively clustering website in relation to their content and the user query, user behavior, session characteristics actions, and profile.

According to some embodiments of the invention, mapping a web-page or a document to a point in a high-dimensional space may comprise indexing the sequence of all the n legal words in at least one language by w₁;w₂; : : : ;wₙ, in an arbitrary order. A document for which the word w₁ appears x₁ times, the word w₂ appears x₂ times, and so on, may be mapped to the point p=(x₁; : : : ; xₙ), where xᵢ is the i^{th} coordinate of p. A query that consists of the words w₁ and w₂ would be mapped to the plane that is defined by the points (xᵢ; x₂; 0; 0; : : : ; 0), for any two real numbers x₁ and x₂.

For a better understanding of the invention, the usages of the following terms in the present disclosure are defined in a non-limiting manner:

The term “core-set” of a certain subset of a larger set, as used herein in this application, is defined as a small weighted set of points, that represents the larger set, according to a specific criterion. For example, the sum of distances to a given center (line, point, etc) is approximately the same from the original set of points and the coreset.

The term “user behavior” as used herein in this application, is defined as all the knowledge that may be collected about each user, in a current and/or previous search and browsing sessions or other network activities (such as calls, send/receive SMS, messages etc.). This includes, for example, all the queries the users typed in the past, all the web-pages that were visiting, the time that was spent on each site, links from the search results page that were ignored, suggested queries that the users declined, and so on.

The term “inverse search” as used herein in this application, is defined as seeking queries based on a given set of web-sites and actions for the relevant queries to the users, as opposed to a regular internet search, in which one looks for a set of relevant web-sites, based on a user's query. The suggestions are given in real time during user browsing, based on their behavior as defined above. Whereas in a regular search, the input is a query (that is mapped to a plane) and the output is a set of related documents (that correspond to points around the plane), in an inverse search the input is a set of points, which represent the documents and links that the user visited or was interested in, whereas the output is the plane which is closest to all the input points. This plane corresponds to at least one output query that may be presented or suggested to the user. Inverse search may further comprise implementing the suggested queries by way of redirection to specified sites. In the general inverse search problem several queries may be returned to the user, which corresponds to the case where the input points are clustered around a few sets of planes.

The term “weight” as used herein in this application, is defined as the importance of an input point. For example, if a user spent a lot of time in a specific site, more weight is given to this site. If a user is not interested in a site (e.g. ignoring the link to the site in a results page), the respective point may receive a negative weight. The coordinations of each point may also be weighted. For example, special words (e.g. words that appear in the title of a document, underlined words, words in a special font etc.) may be counted as a word that appears several times in the regular text.

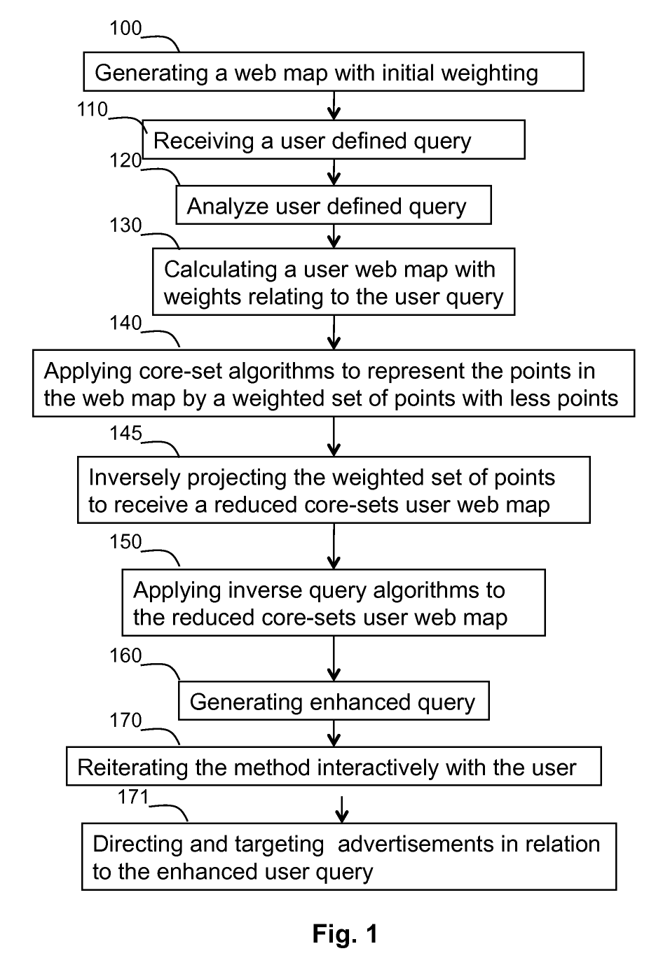

FIG. 1 is a flowchart illustrating a computer implemented method of enhancing a search session applicable to a search engine, according to some embodiments of the invention. The computer implemented method comprises the stages: Generating a knowledge map with initial weighting (stage 100); receiving a user search session comprising at least one search query (stage 110); analyzing user defined search session (stage 120) or receiving analyzed user search session; calculating a user web map with weights relating to the user session (stage 130); applying at least one core-set algorithm to represent the points in the web map by a weighted set of points with less points (stage 140); inversely projecting the weighted set of points to receive a reduced core-sets user web map (stage 145); applying at least one inverse search algorithm to the reduced core-sets user web map (stage 150), thus reducing significantly the number of core-set points in respect to the number of points in the user web map; generating at least one enhanced query (stage 160); and reiterating the method interactively with the user (stage 170). Reiterating the method interactively with the user (stage 170) may comprise automatic enhancement of the method reiteration. The method may further comprise directing and targeting advertisements in relation to the enhanced user query (stage 171).

According to some embodiments of the invention, applying core-set algorithm to represent the points in the web map by a weighted set of points with less points (stage 140) is carried out according to predefined geometrical relationships, such that the number points in the weighted set is substantially smaller than the number of the points in the user web map, and such that weighting is carried out in relation to the predefined geometrical relationships.

According to some embodiments of the invention, generating a knowledge map with initial weighting (stage 100) may comprise using dictionaries and collections such as Wikipedia, which represents the common knowledge of humans. These documents are mapped to a set of points in a space that is used for analyzing all the users data. In order to analyze the behavior of a specific user, the user's data such as personal history, is merged into this space as a new set of points.

According to some embodiments of the invention, receiving a user search session (stage 110) may comprise recording user actions during the session (such as moving a mouse over results) and utilizing these actions in the analysis (stage 120) and calculations (stage 130) as well.

According to some embodiments of the invention, the method may further incorporate statistics relating to a multiplicity of user sessions from various users into any of the stages of the method (e.g. stage 120, stage 140, stage 150).

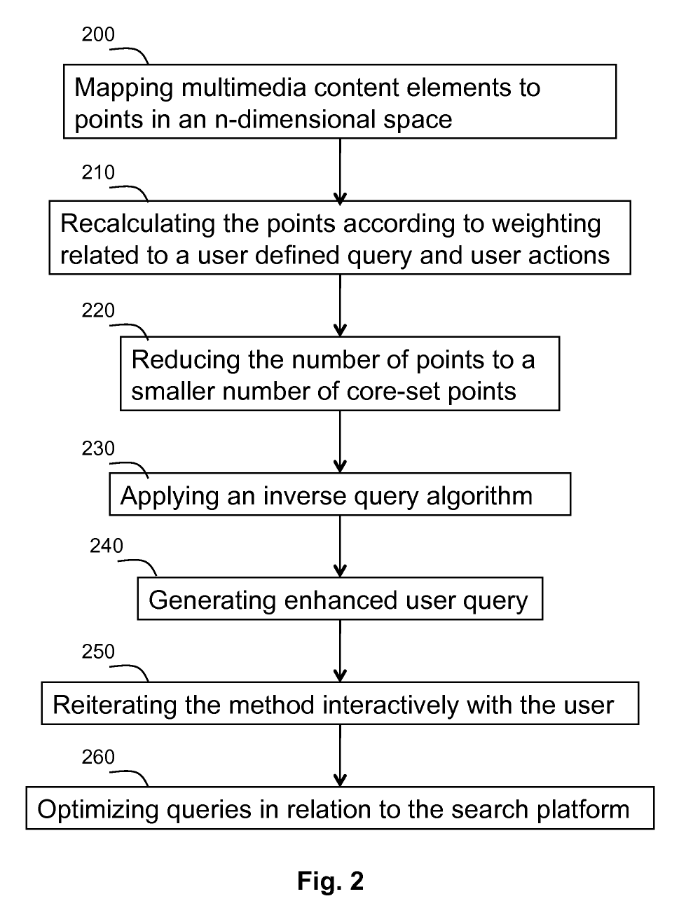

According to some embodiments of the invention, the following algorithms may be used as inverse search algorithms (stage 150): Lloyd's algorithm (Voronoi iteration); constant-factor approximation algorithm for the k-median problem (Charikar et al.); algorithms determining the centroid coordinates, the distances of each object to the centroids and grouping the objects based on minimum distances; and matrix approximation and projective clustering via volume sampling (Deshpande et al., 2006). FIG. 2 is a flowchart illustrating, one of the innovation potential applications, a computerized method of reducing complexity of an inverse search process over a plurality of multimedia content elements mapped to a plurality of points in a d-dimensional space, according to some embodiments of the invention. The computerized method comprises the stages: Mapping multimedia content elements to a plurality of points in a d-dimensional space (stage 200); recalculating the points according to weighting related to a user session and user actions (stage 210); reducing the number of points to a smaller number of core-set points (stage 220), e.g., mapping the plurality of points to a plurality of weighted new virtual points by core-set such that the number of the core-set points is substantially smaller than the number of the points; applying at least one inverse search algorithm to the plurality of core-set points (stage 230); generating and recommending at least one enhanced user query (stage 240); and reiterating the method interactively with the user (stage 250). Using corsets, algorithms like pagerank and LSA can be computed after one pass over streaming data, and not by few hundreds of iterations, as in the usual techniques.

According to some embodiments of the invention, the computerized method may further comprise optimizing queries in relation to the search platform (stage 260). Different embodiments of algorithms may be adopted relating to search session characteristics such as the used platform, media type, protocols, search engine, interfaces, add-ons etc.

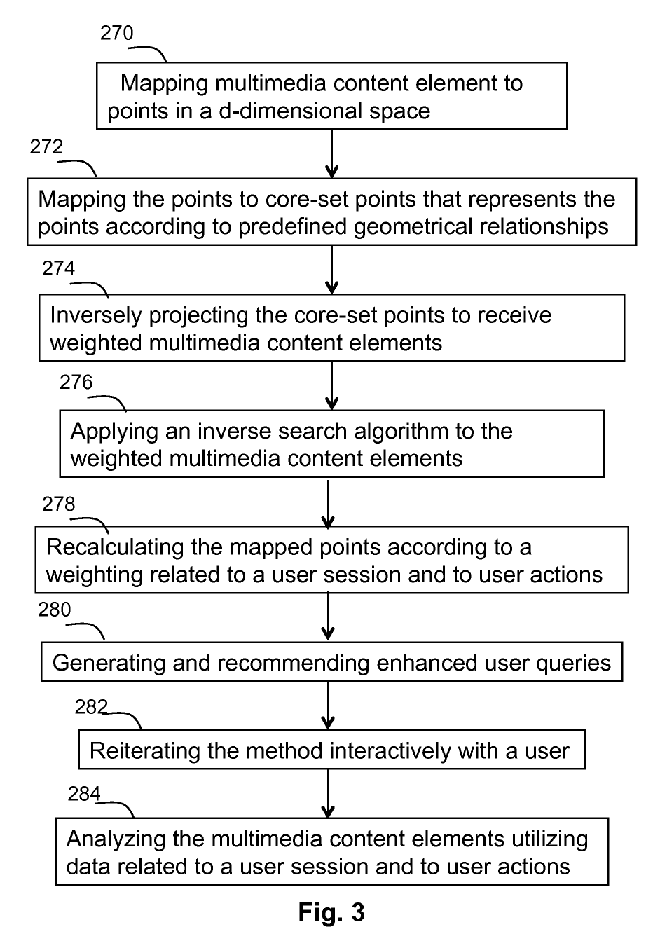

FIG. 3 is a flowchart illustrating a computerized method of reducing complexity of an inverse search process over a plurality of multimedia content, according to some embodiments of the invention. The computerized method comprises the following stages: Mapping the multimedia content element to points in a d-dimensional space (stage 270); mapping the points to core-set points (stage 272). The core-set points comprise a weighted set of points, that represents the points (onto which the multimedia content element were mapped in stage 270) according to predefined geometrical relationships. The number of the core-set points is substantially smaller than the number of the points (onto which the multimedia content element were mapped in stage 270). The computerized method further comprises the following stages: inversely projecting the core-set points to receive weighted multimedia content elements (stage 274), such that weighting is carried out in relation to the geometrical relationships among the core-set points; and applying at least one inverse search algorithm to the weighted multimedia content elements (stage 276).

According to some embodiments of the invention, the following algorithms may be used as inverse search algorithms (stage 276): Lloyd's algorithm (Voronoi iteration); constant-factor approximation algorithm for the k-median problem (Charikar et al.); algorithms determining the centroid coordinates, the distances of each object to the centroids and grouping the objects based on minimum distances; and matrix approximation and projective clustering via volume sampling (Deshpande et al., 2006).

According to some embodiments of the invention, the computerized method may further comprise any of the following stages: recalculating the mapped points according to a weighting related to a user session and to user actions (stage 278); generating and recommending at least one enhanced user query (stage 280); reiterating the computerized method interactively with a user (stage 282); and analyzing the plurality of multimedia content elements utilizing data (stage 284) related to at least one of: history of the user; social knowledge; users' context, minds, and identities; a directory-like ordering thereof; and linguistics, and utilizing the analyzing (stage 284) to enhance the mapping (stage 272).

According to some embodiments of the invention, the computerized method may further comprise directing advertisements in relation to the weighting (stage 274). The computerized method may further comprise directing advertisements in relation to the enhanced user query and/or its analyzed behavior (stage 280).

According to some embodiments of the invention, the method may utilize various user personal intention, need and behavioral session data that may comprise, inter alia, visited pages, mouse actions, search terms etc. Yet, the method may operate without reference to user search terms, e.g., for a user browsing web pages of a content provider. The advertisements may be specific in respect to the user, the time, the web page and the placing on the web page (time, space and user sharing), such as to generate more efficient advertising, or to minimize advertising to an aimed minimum. Advertisers, on the other hand, may be allowed to bid for advertising slots that may be exactly defined in time, space and user profile, allowing them to concentrate their advertising efforts, as well as allowing them to achieve maximal impact for a small budget. Moreover, they may advertise to user that don't conduct a search and/or was not included in the definitions of the advertisement campaign and thus may reach these users more effectively.

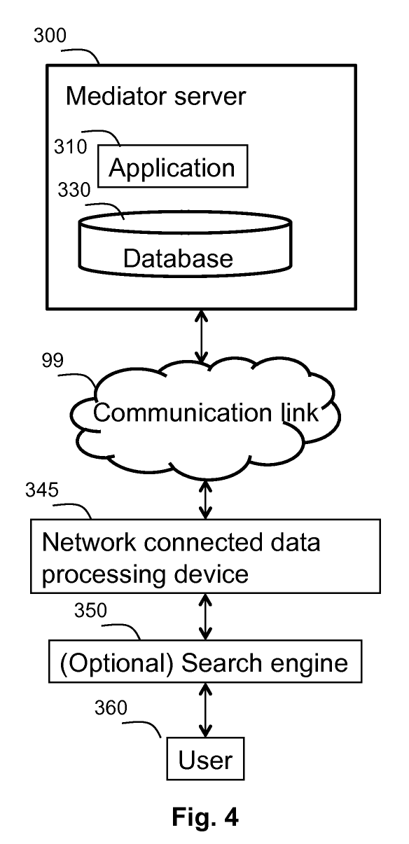

FIG. 4 is a block diagram illustrating a data processing system for enhancing a search session applicable to a search engine, according to some embodiments of the invention. The data processing system comprises a mediator server 300 comprising a database 330 and an application 310. Mediator server 300 may be connected via a communication link 99 to either a search engine 350 fed with queries from a user 360, or directly to user 360. Mediator server 300 may be arranged to receive at least one user session from search engine 350 or directly from user 360. Database 330 may be arranged to comprise at least one weighed representation of the web comprising points, wherein the weights relate to the user session, and at least one core-set representation of the weighed representation of the web. The core-set representation comprises a weighted set of the points that represents the web according to predefined geometrical relationships. The number of the points in the weighted set is substantially smaller than the number of the points in the weighed representation of the web.

Application 310 may be arranged to calculate the core-set representation from the weighed representation of the web. Application 310 may be further arranged to inversely project the core-set representation to receive weighted multimedia content elements, such that weighting is carried out in relation to the geometrical relationships among the points in the weighted set. Application 310 may be further arranged to carry out inverse search algorithms. Mediator server 300 may be arranged to be engaged in a session with user 360 via search engine 350, during which mediator server 300 may generate enhanced search queries relating to the user session.

According to some embodiments of the invention, database 330 may comprise information sources such as dictionaries and collections (e.g. Wikipedia), in order to imitate the common knowledge of humans. These information sources may be mapped to a set of points in a space that is used for analyzing all the users. In order to analyze the need of a specific user, the user's data such as personal history (pre-defined query and-or selected data or content components, is merged into this space as a new set of points.

According to some embodiments of the invention, queries may be inputted by user 360 via any device, such as a computer, a laptop, a mobile device such as a mobile phone or a personal digital assistant and so forth. Communication link 99 may comprise for example the internet, a cellular network, a local wireless network and so forth. Search engine 350 may comprise any search engine operable on the user's device, including search engines operable on the internet and on cellular networks.

According to some embodiments of the invention, the data processing system may enhance a data session on a user's network connected data processing device 345. The data processing system may comprise a mediator server 300 connected via communication link 99 to user's network connected data processing device 345 and arranged to receive a user session from user's network connected data processing device 345. Mediator server 300 may comprise database 330 and application 310.

Database 330 may be arranged to comprise at least one weighed representation of the web comprising a plurality of points, wherein the weights relate to the user session; and at least one core-set representation of the weighed representation of the web, the at least one core-set representation comprising a weighted set of points that represents the plurality of points according to predefined geometrical relationships, such that the number of the points in the weighted set is substantially smaller than the number of the points in the weighed representation of the web.

Application 310 may be arranged to calculate the at least one core-set representation from the weighed representation of the web; further arranged to inversely project the at least one core-set representation to receive a plurality of weighted multimedia content elements, such that weighting is carried out in relation to the geometrical relationships among the points in the weighted set; and further arranged to carry out at least one inverse search algorithm.

Mediator server 300 may be arranged to engage in a session with user 360 and generate enhanced search queries relating to the user session.

Database 330 may comprise mappings of dictionaries and collections of information utilized to generate a knowledge map with initial weighting. Mediator server 300 may be further arranged to analyze recorded user actions, statistics relating to past user sessions; history of the user; social knowledge; users' context, minds, and identities; a directory-like ordering thereof; and linguistics, and further arranged to utilize the analysis to enhance the weighed representation of the web. The inverse search algorithm may comprise Lloyd's algorithm; constant-factor approximation algorithm for the k-median problem; algorithms determining the centroid coordinates, the distances of each object to the centroids and grouping the objects based on minimum distances; and matrix approximation and projective clustering via volume sampling.

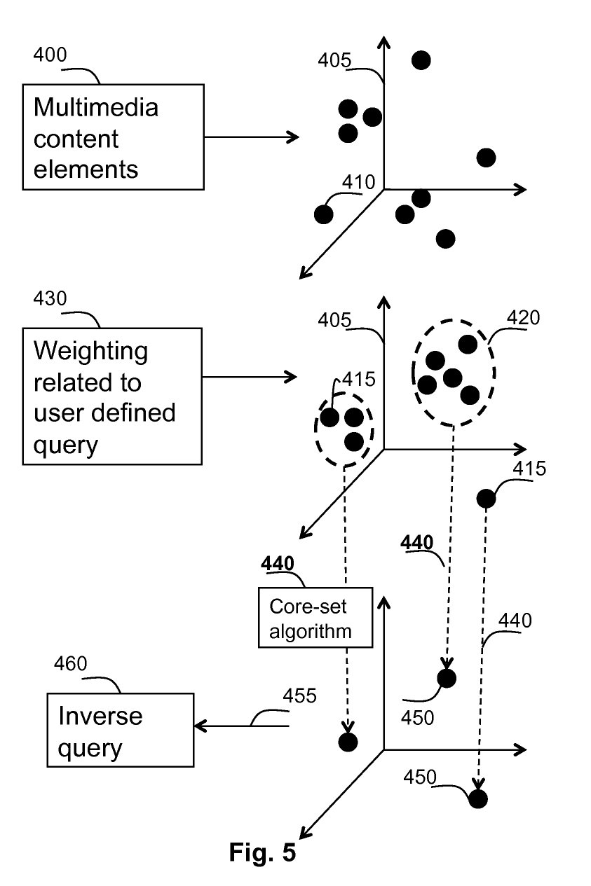

FIG. 5 is an illustration of web representations with inputs and outputs, according to some embodiments of the invention. Multimedia content elements 400 may be mapped to points 410 in a d-dimensional space (axes 405 may represent query parameters). The user related query may be analyzed to generate weights (by weighting related to user defined query 430) which determine the positions of weighed points 415. A core-set algorithm 440 maps clusters 420 of weighed points 415 to core-set points 450 in a much smaller number. Inverse search algorithms 455 may generate an inverse query 460.

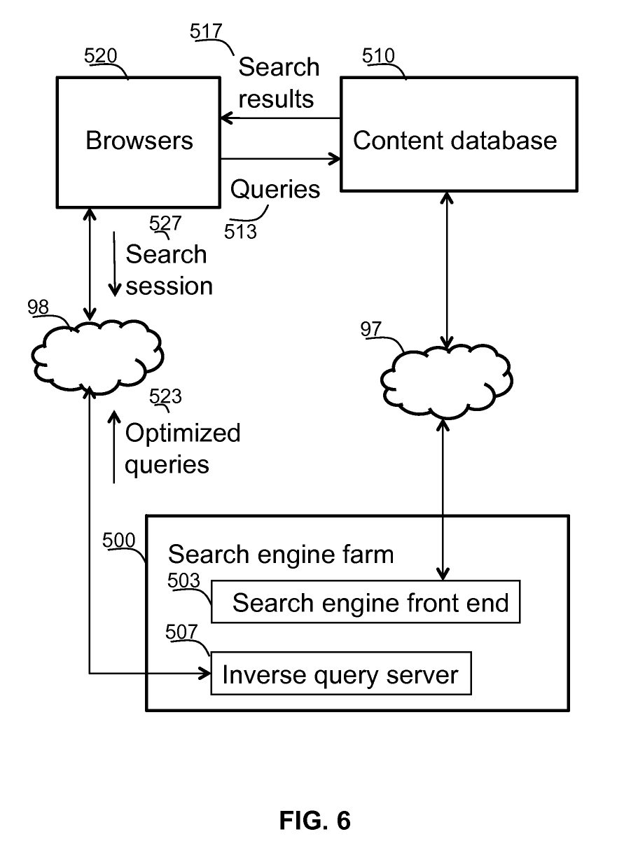

FIG. 6 is a block diagram illustrating the information flow in a data processing system for enhancing user search sessions 527 applicable to a search engine in a search engine farm 500, according to some embodiments of the invention. Search engine farm 500 comprises a search engine front end 503 and an inverse query server 507. Browsers 520 are connected via communication link 98 to inverse query server 507 may deliver search sessions 527 as input and eventually receive optimized queries 523 as output. Search engine front end 503 is connected via communication link 97 to content databases 510 (such as XML over HTTP, the web in general, a cellular network, IPTV, or other databases). Search engine front end 503 may apply queries 513 related to search sessions 527 to content databases 510 and receive search results 517. Browsers 520 may comprise Ajax based web 2.0 user interface, toolbars, add-ons etc. relating to the data processing system.

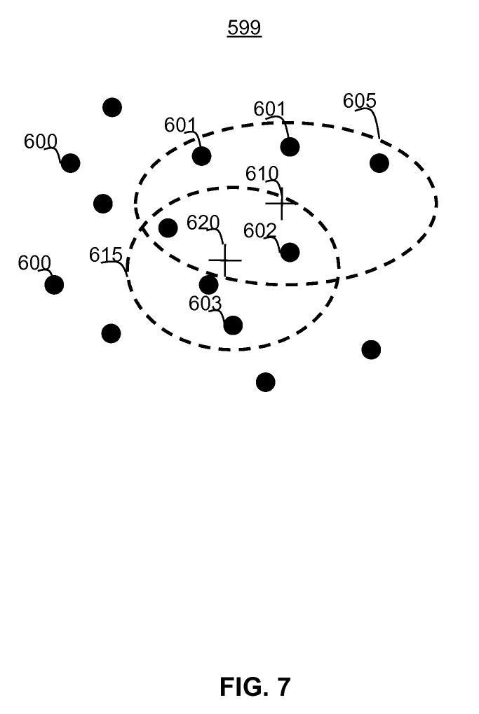

FIG. 7 is an illustration of the dynamic focus of the system and method on user's intentions in the search, according to some embodiments of the invention. Points 600 represent points in the informational space 599, e.g. keywords from websites. A user query 605 may retrieve a group of points 601, 602 centered around a query focus 610. The system and method may identify from user actions, user search session, or other data that the user has probably searched for information fitting a modified query 615 with a modified query focus 620 and comprising a different group of points 602, 603. Some of the points 602 may be common to both groups, i.e. qualify as results of both user query 605 and modified query 615.

For example, an initial query with the word “Safari” may retrieve webpages relating to either an overland journey or to the web browser (as well as to other subjects). The system and method may identify that the user is actually interested in web browsers and retrieve only the results of the initial query that relate to web browser.

According to some embodiments of the invention, the systems and methods replace clusters of points by core sets and reduce the overall number of point logarithmically. This reduction allows applying conventional search optimization algorithms on the one hand, whereas the algorithm is constructed to conserve the information that is relevant to the user, i.e. the relevant search results the user was hoping to reach by the query.

According to some embodiments of the invention, the algorithms for constructing core-sets deal efficiently with huge amount of data, returns results that are mathematically proven to be an approximation to the optimal calculation. Furthermore, the algorithms update the optimal solution dynamically when the input is changed, and store a very small fraction of the input data (i.e. they are streaming algorithms).

According to some embodiments of the invention, and with reference to FIG. 4, search engine 350 may enable search in an arbitrary content database. Search engine 350 may or may not be web-based. Search engine 350 may enable searching the web, cellular networks, IP based networks such as IPTV, databases. Search engine 350 may enable searching any kind of content such as text, visual content, audio content, video content, multimedia content and combinations thereof. Search engine 350 may utilize any informational medium and any data infrastructure.

The system and method may utilize any of the following sources to analyze user behavior, queries and enhance the core sets analysis and the effectivity of inverse query production. These are based on user behavior as defined above, and include user's actions, user's decisions, options ignored by the user, etc., which are usually much richer and easier to supply than terms in a query. The following sources comprise of the history of the user, social knowledge and users' context, minds, and identities as explained below.

History of the user. Some search engines make simple suggestions that are based on the last typed query. For example, “Did you mean Brittney Spears”, when typing “Breatny Spears” in Google. The system and method may record all the actions of the users during their current and previous sessions, including all the sites that the user visited, the time that was spent on each site, all the queries that the user typed in Google, and much more. Since the system and method may store the web-pages and the links that the user clicked, they can also deduce which links the user saw and ignored. This is especially useful for guessing what the user is not interested in, e.g. when pages containing many links are displayed to the user, such as a result page of Google, or a page on Wikipedia. The history also includes all the reactions of the user to suggestions generated by the system and method.

Social knowledge. The user is probably not the first one who is searching for what you are currently searching for, or interested in the sites that you are interested in. By comparing a user's history with the history of other users, the system and method may suggest sites that are popular according to people with similar user behavior. Instead of repeating the struggles of other users who were in your position, the system and method may provide the user with ready-made tips that are based on the sessions of these users. Tips may be suggested “on the fly” according to users who were in a situation or context that is very similar to the user's current one. A “tip” may be e.g. suggested search queries, a “context directory” which is a directory that represent tree of sites that are relevant now, a personalized commercial, or a directory of “road maps” that contain summary of related sessions.

Users context, minds, and identities. Usually, there is a connection between a user's current session and the previous sessions. Maybe this is another session that relates to the user's ski vacation, the user's thesis work, or maybe the user is back at the office and the current session is related to the user's everyday work. Instead of “reinventing the wheel”, the system and method may filter search results, and focus the user's session to the user's current context and aspect of life (“current identity”). The system and method may try to guess what is the user's current identity and context, by comparing the user's history with the sites that the user is currently browsing. Since this might be hard, and require some learning time, the system and method may let the user focus on a specific context in a tree of subjects, or automatically create a new subject. The subjects of the tree are based on subjects that were typed by the user, chosen from a pre-defined directory tree, or subjects that was suggested by the system and method according to the user's history (such as queries and data (i.e web-pages) content). The system and method may store a “database of identities” that contains sessions that are related to specific subjects. If the user is a Phd student, Harry Potter fan, or planning a vacation, the user may choose an identity from the database with a history that matches the user's needs. This helps the system and method to know the user better, even before the users starts the session. Based on the three sources of information above, the user is notified by the system and method about: text queries for a search engine, a directory of sites, or a directory of “internet tours” that contains a map of relevant surfing paths.

According to some embodiments of the invention, the system and method may produce messages related to the user session “on the fly” that suggest ways for a more efficient and interesting ways to continue the session. One of the modes may comprise an automatic of semi automatic mode, guiding the user through the session. The user now chooses a relevant site from the search results, and a new query is constructed based on this choice. The new query is transferred again to the search engine, new search results are displayed, and so on. This allows a user to brows following suggestions of the system and method, without having to formulate queries.

The systems and methods utilize data relating to the history of the user, to social knowledge and to users' context, minds, and identities and incorporate the data into the inverse query algorithms and core-set algorithms. In addition, directory-like data and linguistic data are utilized to enhance the algorithms.

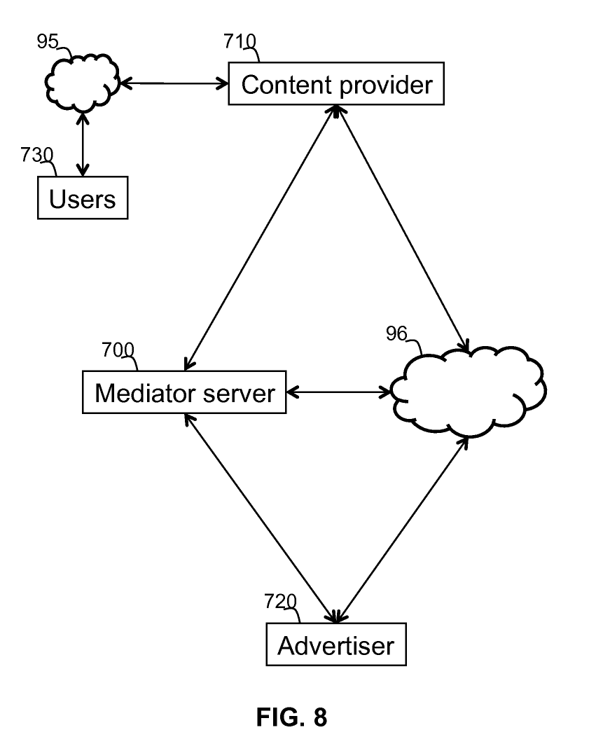

FIG. 8 is a high level schematic block diagram of personalized and targeted advertising system utilizing methods described in some embodiments of the invention. The system comprises a mediator server 700, an advertiser 720 and a content provider 710, all interconnected via a communication link 96. Content provider 710 is connected to users 730 via a communication link 95. Mediator server 700 applies algorithms and methods described above, and especially the core-set algorithm, to characterize sessions of users 730 browsing content provided by content provider 710. In particular, mediator server 700 carries out inverse search algorithms (stage 276) according to user session data in relation to the mapping (stages 270, 272) and the projection of the coreset points (stage 274). The user session data may, but must not contain search terms, and may comprise solely visited pages and mouse actions and/or other user browsing behavior elements. Then, mediator server 700 allows advertiser 720 to define a user session profile, according to which advertisements will be presented by content provider 710 to users 730 exhibiting the user session profile. The system thus allows directing advertisements to users 730 not searching but browsing content provided by content provider 710. The system further allows content provider 710 to enable advertising at predefined time and space slots, in relation to specific users. The system may operate in real time, allow advertisers 720 to advertise for users 730 in their current sessions. The system may further allow online bidding for such time and space slots.

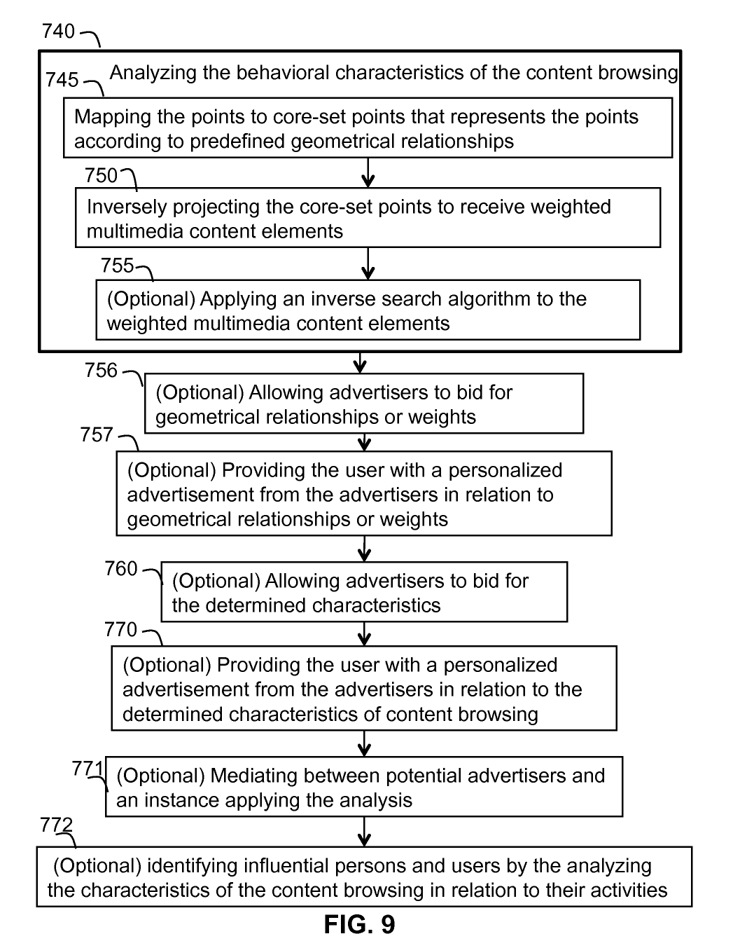

FIG. 9 is a high level schematic flowchart illustrating a method of generating personalized advertising relating to behavioral characteristics of content browsing by a user, according to some embodiments of the invention. Content browsing may be carried out over a space comprising multimedia content elements mapped to points in a d-dimensional space. The method comprises the following stages: analyzing the characteristics of the content browsing (stage 740); optionally allowing at least one advertiser to bid for the determined characteristics (stage 760); and optionally providing the user with a personalized advertisement from the at least one advertiser in relation to the determined characteristics of content browsing (stage 770). Alternatively, the method may comprise: allowing at least one advertiser to bid in relation to the geometrical relationships and/or the weighting of the weighted multimedia content elements (stage 756); and providing the user with a personalized advertisement from the at least one advertiser in relation to the geometrical relationships, and/or the weighting of the weighted multimedia content elements (stage 757). The latter option allows utilizing the method without using the inverse search algorithm, which allows broadening the context of its application.

According to some embodiments of the invention, the method allows a content provider to optimize offers of advertising to browsing users in relation to space, time and user's behavior considerations. Analyzing the characteristics of the content browsing (stage 740) may comprise the following stages: mapping the points to core-set points (stage 745), comprising a weighted set of points that represents the points according to predefined geometrical relationships, such that the number of the core-set points is substantially smaller than the number of the points; inversely projecting the core-set points to receive weighted multimedia content elements (stage 750), such that weighting is carried out in relation to the geometrical relationships among the plurality of core-set points; and optionally determining the characteristics of the content browsing by applying at least one inverse search algorithm to the weighted multimedia content elements (stage 755).

According to some embodiments of the invention, the method may relate either to a user that is engaged in a search session, or to a browsing user. In the latter case, the geometrical relationships and the weights themselves may be based upon in generating user customized advertisement.

According to some embodiments of the invention, the method may further comprise mediating between potential advertisers and an instance applying the analysis of stage 740 (stage 771).

According to some embodiments of the invention, the method may further comprise identifying influential persons and users' intention and characteristics by analyzing the characteristics of the content browsing and network behavior of users in relation to their activities.

According to some embodiments of the invention, the method may utilize various user behavioral session data that may comprise visited pages, mouse actions etc., and also search terms. Yet, the method may operate without reference to user search terms, e.g., for a user browsing web pages of a content provider.

According to some embodiments of the invention, the systems and methods may be used in the social networks and/or telecommunication market for identifying influential persons and/or users intention and./or users characteristics according to their activities that may be monitored and analyzed by the systems and methods. The method may further comprise identifying influential persons and users intention and./or users characteristics by the analyzing the characteristics of the content browsing in relation to their activities (stage 772). The utilization of the core-set methodology and algorithm, and core-set based system and methods, may allow analyzing the large amount of data involved in recognizing and analyzing the activity of such influential persons and users. Their identification may be utilized to enable better marketing, advertising and products promotions as well as improving clients/customer relations, new customer/client acquisitions, satisfaction activities, brand messages, users interactions etc.

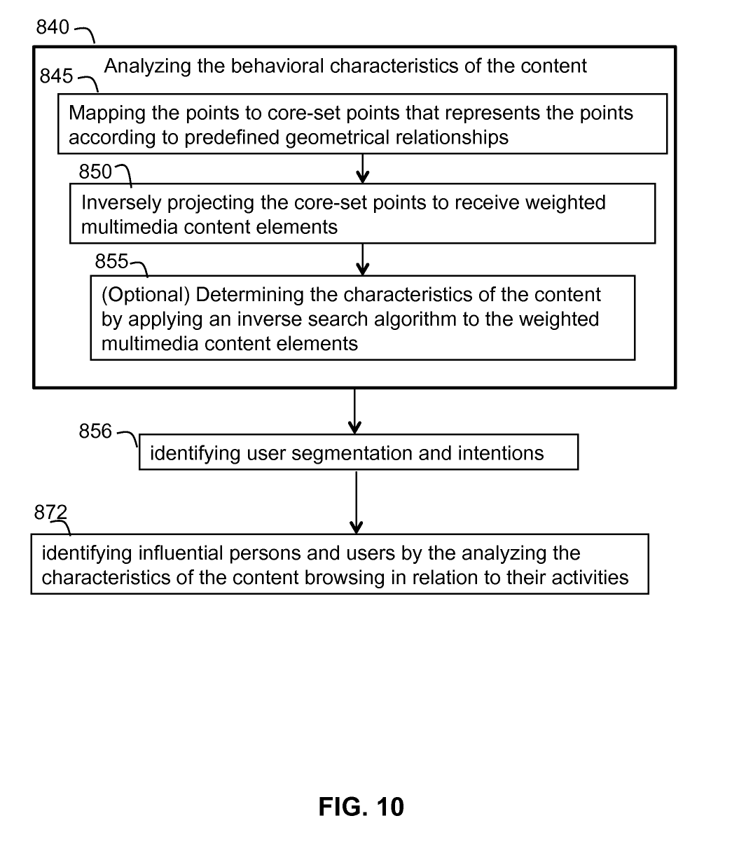

FIG. 10 is a high level schematic flowchart illustrating a method of identifying influential persons and users intention and characteristics by the analyzing the characteristics of the network behavior of users in relation to their activities, according to some embodiments of the invention. Content browsing may be carried out over a space comprising multimedia content elements mapped to points in a d-dimensional space. The method comprises the following stages: analyzing the characteristics of the content (stage 840) comprising: mapping the plurality of points to a plurality of core-set points, comprising a weighted set of points that represents the plurality of points according to predefined geometrical relationships (stage 845), such that the number of the core-set points is substantially smaller than the number of the points; inversely projecting the plurality of core-set points to receive a plurality of weighted multimedia content elements (stage 850), such that the weighting is carried out in relation to the geometrical relationships among the plurality of core-set points; and optionally determining the characteristics of the content by applying at least one inverse search algorithm to the plurality of weighted multimedia content elements (stage 855), and identify user segmentation and intentions (stage 856) in relation to at least one of: the geometrical relationships, the weighting of the weighted multimedia content elements. The method allows to optimize offers of marketing, advertising and interactions to users in relation to space and time considerations. The method may further comprise identifying influential persons and users intention and characteristics (stage 872) by analyzing the characteristics of the content and network behavior of users in relation to their activities (stage 840).

According to some embodiments of the invention, the system and method may allow a provider add advertisements that are specific in respect to the user, the time, the web page and the placing on the web page (time, space and user sharing), such as to generate more efficient advertising, or to minimize advertising to an aimed minimum. Advertisers, on the other hand, may be allowed to bid for advertising slots that may be exactly defined in time, space and user profile, allowing them to concentrate their advertising efforts, as well as allowing them to achieve maximal impact for a small budget. Moreover, the may advertise to user that don't conduct a search and/or was not included in the definitions of the advertisement campaign and thus may reach these users more effectively.

The invention solves the problem of current systems to deals efficiently with huge amount of data on real time in order to analyze network users. purposes, desires, expectations and characteristics based on actual network behavior.

The utilization of the core-set methodology and algorithm, and core-set based system and methods, allows analyzing the large amount of data involved in recognizing and analyzing the activity of users in any kind of networks such as the web, telecommunication etc. for improving search, advertising and database analysis efficiency.

The present invention intends to improve search, advertising and database analysis efficiency, by utilization of the core-set methodology and algorithm, and core-set based system and methods.

One objective of the invention is to create an apparatus for generating an optimal inverse search query based on the user behavior during search and/or browsing session.

Another objective of the invention is to enhance the ability to focus ads toward a target audience based on the actual user behavior during search and/or browsing session based on the Core-set geometrical approximated method and/or the inverse search query.

An additional objective of the invention is to identify influential persons and networks users intents according to their activities that may be monitored and analyzed by the systems and methods in order to enable better marketing, advertising and products promotions as well as improving clients/customer relations, new customer/client acquisitions, Satisfaction activities Brand messages, users interactions etc. In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A computerized method of reducing complexity of data analysis management, including a personalized and an inverse search process over a plurality of multimedia content elements mapped to a plurality of points in a d-dimensional space, the computerized method comprising:
mapping the plurality of points to a plurality of core-set points, comprising a weighted set of points that represents the plurality of points according to predefined geometrical relationships, such that the number of the core-set points is substantially smaller than the number of the points;
inversely projecting the plurality of core-set points to receive a plurality of weighted multimedia content elements, such that weighting is carried out in relation to the geometrical relationships among the plurality of core-set points; and
applying at least one inverse search algorithm to the plurality of weighted multimedia content elements,
wherein at least one of the mapping, the projecting, and the applying is executed by at least one processor.

2. The computerized method of claim 1, further comprising recalculating the plurality of points according to a weighting related to a user session and to user actions.

3. The computerized method of claim 2, further comprising directing advertisements in relation to the weighting.

4. The computerized method of claim 2, further comprising linking data content components i.e. documents, numbers, reports . . . in relation to the weighting.

5. The computerized method of claim 1, further comprising generating and recommending at least one enhanced user query.

6. The computerized method of claim 1, further comprising analyzing the plurality of multimedia content elements utilizing data related to at least one of: history of the user; social knowledge; users' context, minds, and identities; a directory-like ordering thereof; and linguistics, and utilizing the analyzing to enhance the mapping.

7. The computerized method of claim 1, wherein the at least one inverse search algorithm comprises at least one of: Lloyd's algorithm; constant-factor approximation algorithm for the k-median problem; algorithms determining the centroid coordinates, the distances of each object to the centroids and grouping the objects based on minimum distances; and matrix approximation and projective clustering via volume sampling.

8. A computer implemented method of enhancing a search session applicable to a search engine, the computer implemented method comprising:
generating a knowledge map with initial weighting;
receiving a user search session comprising at least one search query;
calculating a user web map with weights relating to the user session;
applying at least one core-set algorithm to represent the points in the user web map by a weighted set of points according to predefined geometrical relationships, such that the number points in the weighted set is substantially smaller than the number of the points in the user web map, and such that weighting is carried out in relation to the predefined geometrical relationships;
inversely projecting the weighted set of points to receive a reduced core-sets user web map;
applying at least one inverse search algorithm to the reduced core-sets user web map; generating at least one enhanced query; and
reiterating the method interactively with the user.

9. The computer implemented method of claim 8, wherein the generating a knowledge map with initial weighting comprises mapping dictionaries and collections of information in the knowledge map.

10. The computer implemented method of claim 8, further comprising analyzing the user defined search session.

11. The computer implemented method of claim 10, wherein the analyzing the user defined search session comprises analyzing the plurality of multimedia content elements utilizing data related to at least one of: history of the user; social knowledge; users' context, minds, and identities; a directory-like ordering thereof; and linguistics, and utilizing the analyzing to enhance the mapping.

12. The computer implemented method of claim 8, further comprising receiving an analysis of the user search session

13. The computer implemented method of claim 8, wherein the reiterating the method interactively with the user comprises an automatic enhancement of the method reiteration.

14. The computer implemented method of claim 8, wherein the receiving a user search session comprises recording user actions during the session and utilizing recorded user actions in the calculating the user web map.

15. The computer implemented method of claim 8, further comprising incorporating statistics relating to the user sessions from various users into at least one of the method stages.

16. The computer implemented method of claim 8, wherein the at least one inverse search algorithm comprises at least one of: Lloyd's algorithm; constant-factor approximation algorithm for the k-median problem; algorithms determining the centroid coordinates, the distances of each object to the centroids and grouping the objects based on minimum distances; and matrix approximation and projective clustering via volume sampling.

17. A method of generating personalized advertising relating to behavioral characteristics of content browsing by a user, wherein the content browsing is carried out over a space comprising a plurality of multimedia content elements mapped to a plurality of points in a d-dimensional space, the method comprising:
analyzing the characteristics of the content browsing comprising:
mapping the plurality of points to a plurality of core-set points, comprising a weighted set of points that represents the plurality of points according to predefined geometrical relationships, such that the number of the core-set points is substantially smaller than the number of the points; and
inversely projecting the plurality of core-set points to receive a plurality of weighted multimedia content elements, such that the weighting is carried out in relation to the geometrical relationships among the plurality of core-set points,
allowing at least one advertiser to bid in relation to at least one of: the geometrical relationships, the weighting of the weighted multimedia content elements; and
providing the user with a personalized advertisement from the at least one advertiser in relation to at least one of: the geometrical relationships, the weighting of the weighted multimedia content elements,
wherein the method allows a content provider to optimize offers of advertising to browsing users in relation to space and time considerations.

18. The method of claim 17, wherein the analyzing the characteristics of the content browsing further comprises determining the characteristics of the content browsing by applying at least one inverse search algorithm to the plurality of weighted multimedia content elements, and wherein the method further comprises:
allowing at least one advertiser to bid for the determined characteristics; and
providing the user with a personalized advertisement from the at least one advertiser in relation to the determined characteristics of content browsing.

19. The method of claim 18, further comprising mediating between potential advertisers and an instance applying the analyzing the characteristics of the content browsing.

20. The method of claim 18, further comprising identifying influential persons and users intention and characteristics by the analyzing the characteristics of the content browsing and network behavior of users in relation to their activities.
